(19) United States
(12) Patent Application Publication
(10) Pub. No.: US 2026/0266254 A1
(43) Pub. Date: Sep. 10, 2026

(54) IGNITION METHOD

(71) Applicant: Save The Planet Co., Ltd., Osaka (JP)

(72) Inventors: Tsutomu KUSUHARA, Osaka (JP); Mitsuhiro IZUMI, Osaka (JP); Hiroyuki KIMURA, Osaka (JP); Akihiro YAMAO, Osaka (JP); Kou WADA, Osaka (JP); Tsuyoshi KONDOU, Osaka (JP); Fumio OKUMURA, Osaka (JP); Shigeki HASEGAWA, Osaka (JP); Kouichi MUNEO, Osaka (JP)

(21) Appl. No.: 19/164,924

(22) PCT Filed: May 19, 2023
(86) PCT No.: PCT/JP2023/018703

§ 371 Date: Sep. 12, 2025

(51) Int. Cl. F02P 3/04; F02M 21/02

(52) U.S. Cl. CPC F02P 3/0407; F02M 21/0206

(57) ABSTRACT

According to an ignition method for this internal combustion engine, in igniting a gaseous fuel containing ammonia and hydrogen supplied to a combustion chamber by discharge produced by a spark plug of an ignition device, total discharge energy provided by the spark plug in one cycle including stages from a compression stroke to an expansion stroke in the combustion chamber of one cylinder is set to 600 mJ or more. This enables improvement in combustibility of the fuel containing ammonia even in a region in which an engine load to the internal combustion engine is low. Consequently, an amount of hydrogen used as a combustion improved can be reduced.

### TECHNICAL FIELD

The present invention relates to an ignition method for an internal combustion engine.

### BACKGROUND ART

Conventionally, in a spark-ignition (SI) reciprocating engine used in an automobile or the like, fossil fuels such as gasoline are used in many cases. However, there is such a problem that fossil fuels, when burned, generate a lot of carbon dioxide that is greenhouse gas. Given this situation, toward realization of a low-carbon society, hydrogen and ammonia are attracting attention as carbon-free fuels replacing fossil fuels. Especially, ammonia has higher energy density than hydrogen, can be easily liquefied, and thus can be efficiently stored and transported. On the other hand, ammonia has a disadvantage of less combustibility than gasoline or hydrogen (refer to FIG. 1). Hence, some contrivance is required to improve combustion of ammonia.

In patent literatures for the background art, an internal combustion engine that performs co-combustion of ammonia and hydrogen for stabilizing combustion of ammonia is disclosed. For example, in Patent Literature 1, an invention regarding an internal combustion engine that performs co-combustion of hydrogen generated by reforming of ammonia and ammonia is disclosed.

### CITATION LIST

### Patent Literature

[Patent Literature 1] Japanese Patent No. 7105021

### SUMMARY OF INVENTION

### Technical Problem

In Patent Literature 1, there is disclosed a power generation system including an ammonia tank (1) in which ammonia serving as an energy source is stored, a hydrogen generation apparatus (A) that reforms ammonia to generate hydrogen and nitrogen, and an internal combustion engine (8) that uses the generated hydrogen as a fuel (paragraph [0012] and FIG. 1). Further, the hydrogen generated in a reformer (4) included in the hydrogen generation apparatus (A) is separated in the reformer (4), is pressurized using a typical compressor, and is temporarily stored in a hydrogen tank (6). Then, the stored hydrogen is supplied to the internal combustion engine (8) via a hydrogen supply line (7) (paragraph [0018]). Moreover, the internal combustion engine (8) performs co-combustion of the supplied hydrogen and residual ammonia, to generate power (paragraph [0053]).

However, to generate a large amount of hydrogen, it is required to increase the size of the reformer, making it difficult to place the reformer near the internal combustion engine having only a limited space. Further, an increase in the size of the reformer involves an increase in power consumption, resulting in an increase in a cost. Moreover, a large amount of hydrogen to be mixed is liable to have adverse effects such as generation of nitrogen oxide (NOx), generation of noises, and the like during combustion. In view of this, there is a demand for a technology for improving combustibility of a fuel containing ammonia by enhancement of ignition energy and contrivance to an ignition method rather than use of a large amount of hydrogen as a combustion improver.

FIG. 2 shows results of measuring a combustion fluctuation rate during combustion of a fuel mixture of ammonia and hydrogen serving as a combustion improver in each of cases in which a mixing ratio X_{NH3} of ammonia (a mole fraction of ammonia in a fuel mixture of ammonia and hydrogen) is “0.6”, “0.7”, “0.8”, and “0.9”, respectively. Note that a combustion fluctuation rate serves as an index for determining combustion stability of an internal combustion engine (engine) and is a value calculated as an “indicated mean effective pressure (standard deviation/mean)×100%”. Meanwhile, in FIG. 2, a horizontal axis represents an ignition timing in the internal combustion engine (a timing of ignition in a spark plug, corresponding to a crank angle before a TDC (top dead center)). A vertical axis represents a combustion fluctuation rate.

Note that FIG. 2 described above to FIG. 7 described later show results of measurement using an apparatus disclosed in FIG. 8 to FIG. 9 described later. Further, the measurement is performed under conditions where no load is applied to the internal combustion engine, the number of revolutions in one cylinder or each of a plurality of cylinders included in the internal combustion engine is 1,000 rpm, an equivalent ratio (a value obtained by division of a theoretical air-fuel ratio by an actual air-fuel ratio) is 1.0, an ignition coil that allows a spark plug to provide discharge energy of 30 mJ is used, and a spark plug having a gap of “0.5 mm” is used. In the following description, such an ignition coil that allows a spark plug to provide discharge energy of 30 mJ and a spark plug having a gap of “0.5 mm” are collectively referred to as a “base ignition system”.

As shown in FIG. 2, it is found that, in a case in which the mixing ratio X_{NH3} of ammonia in the fuel mixture is “0.7” or lower, the combustion fluctuation rate is at a stability limit (approximately 5%) or lower, and combustion is stable. Meanwhile, it is found that, in a case in which the mixing ratio X_{NH3} of ammonia is “0.8” or higher, the combustion fluctuation rate exceeds the stability limit (approximately 5%), and combustion is not stable.

Further, FIG. 3 shows results of measuring an angle ATDC (after the top dead center) at an optimal ignition timing in each of cases in which the mixing ratio X_{NH3} of ammonia is “0.6”, “0.7”, “0.8”, and “0.9”, respectively. The higher the mixing ratio X_{NH3} of ammonia is, the later the ignition of the fuel is and the lower the combustion velocity is. Hence, theoretically, it is predicted that an optimal ignition timing in a case in which the mixing ratio X_{NH3} of ammonia is “0.9” is more advanced than that in a case in which the mixing ratio X_{NH3} of ammonia is “0.8”. However, as shown in FIG. 3, from the results of measurement, it is found that the optimal ignition timing in the “0.9” case is more retarded than that in the “0.8” case. It is considered that this is because too advanced an ignition timing makes it rather difficult to ignite the fuel for reasons that a compression stroke in a cylinder does not proceed and an in-cylinder pressure in the cylinder is still low.

Further, FIG. 4 shows results of measuring a combustion fluctuation rate at an optimal ignition timing in each of cases in which the mixing ratio X_{NH3} of ammonia is “0.6”, “0.7”, “0.8”, and “0.9”, respectively. As shown in FIG. 4, it is found that, in a case in which the mixing ratio X_{NH3} of ammonia is “0.7” or lower, the combustion fluctuation rate is at the stability limit (approximately 5%) or lower, and combustion is stable. Meanwhile, like that in FIG. 2, it is found that, in a case in which the mixing ratio X_{NH3} of ammonia is “0.8” or higher, the combustion fluctuation rate increases beyond the stability limit (approximately 5%), and that, in a case in which the mixing ratio X_{NH3} of ammonia is “0.9” or higher, the combustion fluctuation rate significantly deteriorates.

Further, FIG. 5 shows results of measuring a combustion period (crank angle) required for a mass burning rate (a proportion of mass of a burned fuel to mass of a fuel supplied per cycle in one cylinder) to reach 10%, a combustion period (crank angle) required for a mass burning rate to reach 50%, and a combustion period (crank angle) required for a mass burning rate to reach 90% in each of cases in which the mixing ratio X_{NH3} of ammonia is “0.6”, “0.7”, “0.8”, and “0.9”, respectively. As shown in FIG. 5, the higher the mixing ratio X_{NH3} of ammonia is, the longer the combustion period is, in each case. Especially, it is found that the combustion period required for a mass burning rate to reach 90% is considerably long in the case in which the mixing ratio X_{NH3} of ammonia is “0.9”. This reveals that, in the case in which the mixing ratio X_{NH3} of ammonia is “0.9”, the combustion velocity becomes particularly low around the end of combustion.

Further, FIG. 6 shows results of measuring a relation between the mixing ratio X_{NH3} of ammonia and an angle ATDC (after the top dead center) at each of timings at which a mass burning rate reaches 10%, 50%, and 90%, respectively. In a gasoline engine, in performing ignition at an optimal ignition timing, it is empirically known that a timing at which a mass burning rate reaches 50% is approximately 10° ATDC (after the top dead center). Hence, it is found that similar results are obtained in the cases in which the mixing ratio X_{NH3} of ammonia is “0.6” to “0.8” in FIG. 6. However, it is found that the angle ATDC (after the top dead center) at each of timings at which a mass burning rate reaches 10%, 50%, and 90% is significantly retarded in the case in which the mixing ratio X_{NH3} of ammonia is “0.9”. That is, it is considered that ignition is not performed at an exactly optimal ignition timing in those cases.

In view of the above, in order to find a causal relation between the factor and the result, i.e., an increase in a combustion fluctuation rate, a relation between an indicated mean effective pressure (piston pushing force exerted by combustion of a fuel-containing gaseous mixture) and an angle ATDC (after the top dead center) at a timing at which a mass burning rate reaches 10%, at the start of ignition at 30° BTDC (before the top dead center), in each of cases in which the mixing ratio X_{NH3} of ammonia is “0.8” and “0.9”, is measured. Then, FIG. 7 shows results of the measurement over 400 cycles for each of the cases in which the mixing ratio X_{NH3} of ammonia is “0.8” and “0.9”, respectively. As shown in FIG. 7, it is found that there is a tendency of negative correlation between the indicated mean effective pressure and the timing at which a mass burning rate reaches 10% in the case in which the mixing ratio X_{NH3} of ammonia having a higher combustion fluctuation rate is “0.9”. Specifically, it can be said that the indicated mean effective pressure is low in a cycle in which the timing at which a mass burning rate reaches 10% is retarded. This reveals that earlier formation of an initial flame (=earlier timing at which a mass burning rate reaches 10%) greatly affects the entire combustion. From the above-described outcomes of study, it is found that it is important to improve combustibility in an initial period (form an initial flame kernel), in particular.

It is an object of the present invention to provide a technology that enhances ignition energy and applies contrivance to an ignition method, to thereby reduce an amount of hydrogen used as a combustion improver while improving combustibility of a fuel containing ammonia.

### Solution to Problem

The first invention of the present application is directed to an ignition method for an internal combustion engine in which a gaseous fuel containing ammonia and hydrogen supplied to a combustion chamber is ignited by discharge produced by a spark plug of an ignition device, wherein total discharge energy provided by the spark plug in one cycle including stages from a compression stroke to an expansion stroke in the combustion chamber of one cylinder is 600 mJ or more.

The second invention of the present application is directed to the ignition method according to the first invention, wherein, using an ignition coil formed by electromagnetic coupling of a primary coil and a secondary coil connected to the spark plug in the ignition device, charge control in which a primary current is caused to flow through the primary coil to perform charge, and discharge control in which the primary current flowing through the primary coil is interrupted after the charge control and a high voltage is induced at one end of the secondary coil, to cause discharge to occur in the spark plug in the combustion chamber of the one cylinder, are performed.

The third invention of the present application is directed to the ignition method according to the second invention, wherein a value of a secondary current flowing through the secondary coil at start of discharge is 200 mA or more in the discharge control.

The fourth invention of the present application is directed to the ignition method according to the second invention or the third invention, wherein a period of 0.3 ms or longer in the one cycle is secured as a period in which the value of the secondary current flowing through the secondary coil is 200 mA or more in the discharge control.

The fifth invention of the present application is directed to the ignition method according to any one of the second invention to the fourth invention, wherein the value of the secondary current flowing through the secondary coil at start of discharge is 300 mA or more in the discharge control.

The sixth invention of the present application is directed to the ignition method according to any one of the second invention to the fifth invention, wherein discharge is caused to occur in the spark plug over a period of time from a starting point that is advanced relative to a top dead center by more than 20°, to 20° BTDC or later, in the one cycle, for the discharge control.

The seventh invention of the present application is directed to the ignition method according to any one of the second invention to the sixth invention, wherein discharge is caused to occur in the spark plug over a period of time from the starting point that is advanced relative to the top dead center by more than 20°, to the TDC (top dead center), in the one cycle, for the discharge control.

The eighth invention of the present application is directed to the ignition method according to any one of the second invention to the seventh invention, a value of a secondary current flowing through the secondary coil is kept at 50 mA or more over the period of time from the starting point that is advanced relative to the top dead center by more than 20°, to 20° BTDC or later, in the one cycle, for the discharge control.

The ninth invention of the present application is directed to the ignition method according to any one of the second invention to the eighth invention, wherein the value of the secondary current flowing through the secondary coil is kept at 100 mA or more over the period of time from the starting point that is advanced relative to the top dead center by more than 20°, to 20° BTDC or later, in the one cycle, for the discharge control.

The tenth invention of the present application is directed to the ignition method according to any one of the first invention to the ninth invention, wherein a gap between a center electrode of the spark plug and a ground electrode paired with the center electrode is preferably 1.2 mm or larger and 1.4 mm or smaller.

The eleventh invention of the present application is directed to the ignition method according to any one of the second invention to the ninth invention, wherein the charge control and the discharge control are alternately repeated a plurality of times in the one cycle in the combustion chamber of the one cylinder, and next charge control is performed before an end of discharge performed as the first discharge control in the spark plug in the one cycle.

The twelfth invention of the present application is directed to the ignition method according to any one of the first invention to the eleventh invention, wherein a mixing ratio of ammonia and hydrogen in the gaseous fuel supplied to the combustion chamber is adjusted on the basis of a result of detection of a pressure in the combustion chamber or a result of detection of an ion current flowing through a detection probe placed in the combustion chamber.

The thirteenth invention of the present application is directed to the ignition method according to any one of the second invention to the ninth invention or the eleventh invention, wherein the gaseous fuel supplied to the combustion chamber of the one cylinder is ignited by discharge produced by respective spark plugs in a plurality of the ignition devices, and discharge is caused to occur in the plurality of spark plugs in the combustion chamber of the one cylinder at the same timing in the one cycle, for the discharge control.

The fourteenth invention of the present application is directed to the ignition method according to any one of the first invention to the thirteenth invention, wherein a piston that reciprocates over a period of time from the compression stroke to the expansion stroke in the combustion chamber is controlled such that a position of a top dead center is variable, so that a compression ratio is increased as an engine load to the internal combustion engine decreases and the compression ratio is decreased as the engine load to the internal combustion chamber increases.

The fifteenth invention of the present application is directed to the ignition method according to any one of the first invention to the fourteenth invention, wherein a generated current of an alternator that generates power along with reciprocation of a piston that reciprocates over a period of time from the compression stroke to the expansion stroke in the combustion chamber is controlled, so that the generated current is increased as an engine load to the internal combustion engine decreases and the generated current is decreased as the engine load to the internal combustion engine increases.

### Advantageous Effects of Invention

According to the first invention to the fifteenth invention of the present application, by enhancing ignition energy and applying contrivance to the ignition method, it is possible to improve the combustibility of the fuel containing ammonia even in a region in which an engine load to the internal combustion engine is low. Consequently, an amount of hydrogen used as a combustion improver can be reduced.

Especially, according to the tenth invention of the present application, a volume of a gaseous mixture (gaseous mixture of a fuel and air) subjected to discharge is increased, and a distance between an initial flame kernel and the electrodes is secured. Thus, cooling loss of the electrodes due to the initial flame kernel can be reduced. Hence, the combustion fluctuation rate can be reduced, and the fuel can be more stably burned.

Especially, according to the twelfth invention of the present application, appropriate ignition can be achieved using the results of detection of a pressure in the combustion chamber and an ion current.

Especially, according to the fourteenth invention of the present application, a temperature of the fuel-containing gaseous mixture is increased by an increase in a compression ratio in the region in which an engine load to the internal combustion engine is low, so that the combustibility of the fuel can be increased. Further, by appropriately adjusting a compression ratio, it is possible to further stabilize combustion.

Especially, according to the fifteenth invention of the present application, a load applied to the internal combustion engine by the alternator is increased by an increase in the generated current of the alternator during a low-load (engine load) period. Thus, in order to maintain the number of revolutions, an intake pressure is increased, and hence an in-cylinder pressure is increased, whereby the combustibility of the fuel can be increased. On the other hand, during a high-load (engine load) period, the load applied by the alternator is decreased, whereby more energy produced by combustion of the fuel can be used for a power side.

### BRIEF DESCRIPTION OF DRAWINGS

FIG. 1 is a view showing combustion characteristics (minimum ignition energy and a laminar combustion velocity) of ammonia, gasoline, and hydrogen.

FIG. 2 is a view showing results of measuring a relation between a mixing ratio of ammonia in a fuel mixture and a combustion fluctuation rate.

FIG. 3 is a view showing results of measuring an optimal ignition timing for each mixing ratio of ammonia.

FIG. 4 is a view showing results of measuring a combustion fluctuation rate at an optimal ignition timing for each mixing ratio of ammonia.

FIG. 5 is a view showing results of measuring a combustion period required for a mass burning rate to reach 10%, 50%, and 90%, for each mixing ratio of ammonia.

FIG. 6 is a view showing results of measuring a relation between the mixing ratio of ammonia and an angle ATDC (after a top dead center) at each of timings at which a mass burning rate reaches 10%, 50%, and 90%.

FIG. 7 is a view showing results of measuring a relation between an indicated mean effective pressure and a timing at which a mass burning rate reaches 10% at the start of ignition at 300 BTDC.

FIG. 8 is a block diagram schematically showing an operating environment of an internal combustion engine.

FIG. 9 is a view showing exemplary specifications of the internal combustion engine.

FIG. 10 is a block diagram schematically showing an operating environment of an ignition device.

FIG. 11 is a block diagram schematically showing an operating environment of the ignition device and an ion current detection circuit.

FIG. 12 is a view showing specifications of an ignition coil and a spark plug.

FIG. 13 is a block diagram schematically showing an operating environment in the vicinity of an alternator of the internal combustion engine.

FIG. 14 is a flowchart showing a flow of operations of the internal combustion engine.

FIG. 15 shows time-series data indicating change with time of a pressure in a combustion chamber during the operations shown in FIG. 14.

FIG. 16 is a view showing an ON/OFF state of an igniter and change with time of a secondary current and a secondary voltage.

FIG. 17 is a view showing results of measuring a combustion fluctuation rate during combustion of a fuel mixture of ammonia and hydrogen in each of cases in which total discharge energy provided by the spark plug is set to 600 mJ using an enhanced ignition system and to 30 mJ using a base ignition system, respectively.

FIG. 18 is a view showing variations of specifications of the ignition coil and the spark plug.

FIG. 19A is a view showing change with time of a value of a secondary current flowing through a secondary coil.

FIG. 19B is a view showing change with time of a value of a secondary current flowing through the secondary coil.

FIG. 20 is a view showing results of measuring a relation between discharge energy provided by the spark plug and a combustion fluctuation rate.

FIG. 21 is a view showing results of measuring a relation between a discharge period of the spark plug and a combustion fluctuation rate.

FIG. 22 is a view showing results of measuring a relation between a value of a secondary current in the ignition coil at the start of discharge and a combustion fluctuation rate.

FIG. 23 is a view showing results of measuring a relation between a gap of the spark plug and a combustion fluctuation rate.

FIG. 24 is a view showing results of measuring a relation between a gap of the spark plug and a combustion fluctuation rate.

FIG. 25A is a view showing results of measuring a relation between a load applied to the internal combustion engine and/or the number of revolutions, and a combustion fluctuation rate.

FIG. 25B is a view showing results of measuring a relation between a load applied to the internal combustion engine and/or the number of revolutions, and a combustion fluctuation rate.

FIG. 25C is a view showing results of measuring a relation between a load applied to the internal combustion engine and/or the number of revolutions, and a combustion fluctuation rate.

FIG. 25D is a view showing results of measuring a relation between a load applied to the internal combustion engine and/or the number of revolutions, and a combustion fluctuation rate.

FIG. 25E is a view showing results of measuring a relation between a load applied to the internal combustion engine and/or the number of revolutions, and a combustion fluctuation rate.

FIG. 26A is a view showing results of measuring a relation between a load applied to the internal combustion engine and/or the number of revolutions, and fuel consumption.

FIG. 26B is a view showing results of measuring a relation between a load applied to the internal combustion engine and/or the number of revolutions, and fuel consumption.

FIG. 26C is a view showing results of measuring a relation between a load applied to the internal combustion engine and/or the number of revolutions, and fuel consumption.

FIG. 26D is a view showing results of measuring a relation between a load applied to the internal combustion engine and/or the number of revolutions, and fuel consumption.

FIG. 26E is a view showing results of measuring a relation between a load applied to the internal combustion engine and/or the number of revolutions, and fuel consumption.

FIG. 27 is a view showing results of measuring change with time of a value of a secondary current in multi-ignition in comparison with a case in which ignition is performed using the enhanced ignition system.

FIG. 28 is a view showing results of measuring a combustion fluctuation rate in multi-ignition in comparison with a case in which ignition is performed using the enhanced ignition system.

FIG. 29 is a view showing results of measuring a combustion fluctuation rate in a case in which ignition is performed using the enhanced ignition system in comparison with a case in which ignition is performed using a base ignition system mounted in an existing vehicle.

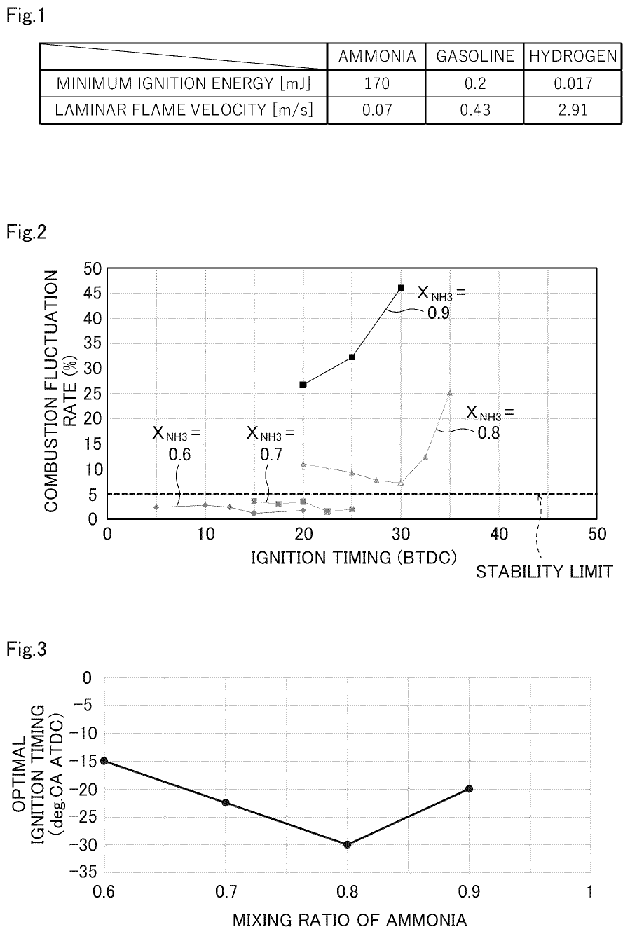

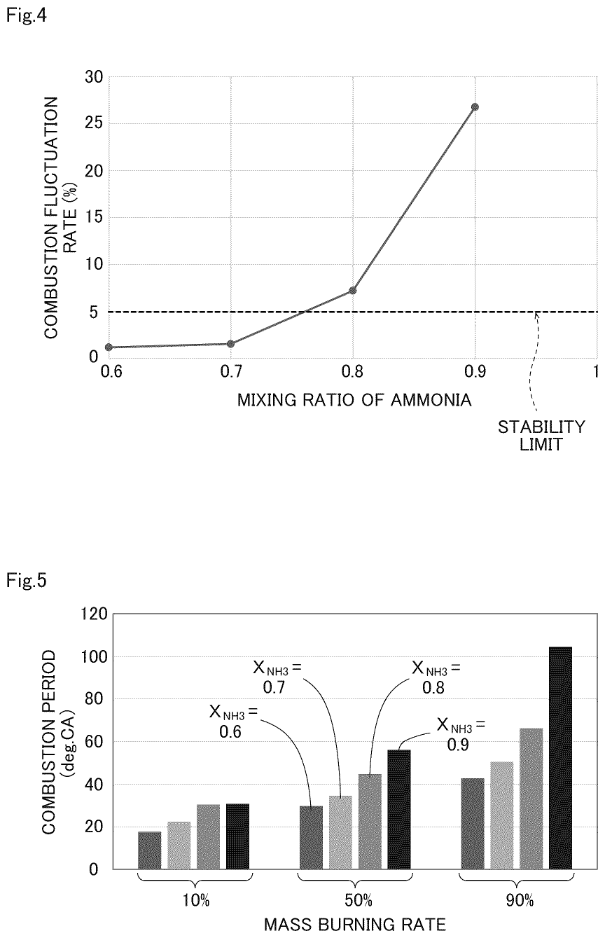

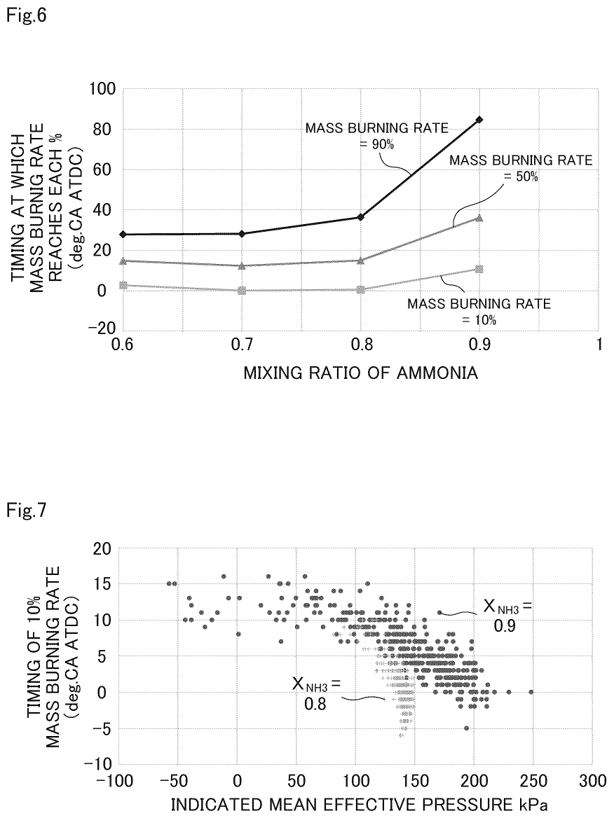

### DESCRIPTION OF EMBODIMENTS

Now, an exemplary embodiment of the present invention is described with reference to the drawings.

### <1. Configuration of Internal Combustion Engine>

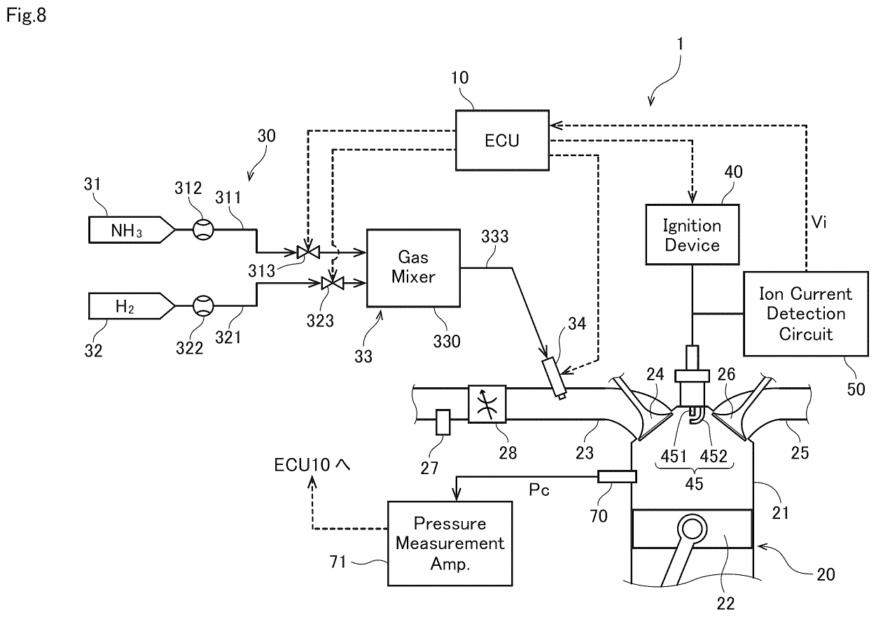

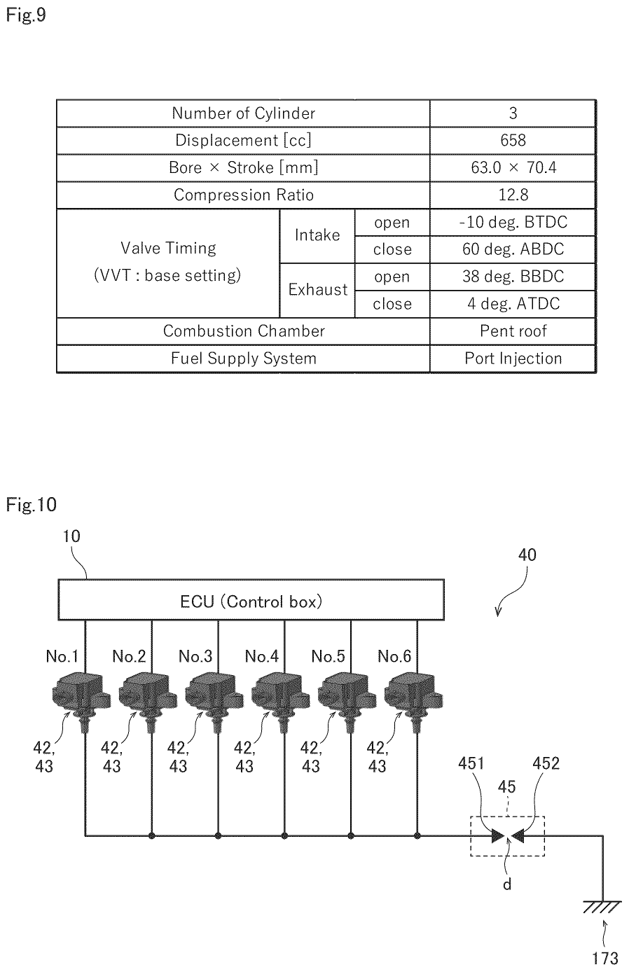

First, a configuration of an internal combustion engine 1 according to one embodiment of the present invention is described with reference to the drawings. FIG. 8 is a block diagram schematically showing an operating environment of the internal combustion engine 1. Note that, in FIG. 8, a part in the vicinity of an alternator 60 described later is omitted in illustration. FIG. 9 is a view showing exemplary specifications of the internal combustion engine 1.

The internal combustion engine 1 of the present embodiment is a device that is mounted in a body of a vehicle such as an automobile and ignites a fuel supplied to a cylinder 20, to generate driving force of the vehicle. The internal combustion engine 1 is, for example, a four-stroke (or four-stroke cycle) reciprocating engine, and opens and closes an exhaust valve 26 and an intake valve 24, introduces a fuel, and performs ignition, along with reciprocation of a piston 22, to thereby repeat an exhaust stroke, an intake stroke, a compression stroke, and an expansion stroke. Further, as shown in FIG. 9, the internal combustion engine 1 of the present embodiment is a three-cylinder internal combustion engine. Note that, in the present embodiment, it is assumed that a fuel containing ammonia and hydrogen is used in the internal combustion engine 1.

As shown in FIG. 8, the internal combustion engine 1 includes an ECU 10, three cylinders 20 each including a combustion chamber 21, a fuel supply unit 30, three ignition devices 40, three ion current detection circuits 50, the alternator 60 described later, and three pressure sensors 70. However, in FIG. 8, only a part relevant to one combustion chamber 21 is shown. Meanwhile, the numbers of the cylinders 20, the ignition devices 40, the ion current detection circuits 50, and the pressure sensors 70 are each not limited to three.

The ECU 10 is an electronic engine control unit (ECU) that controls operations of respective parts of the internal combustion engine 1. The ECU 10 is a computer that is mounted in an automobile and comprehensively controls operations and the like of a transmission and an air bag in a vehicle body. The ECU 10 includes a microcontroller or a computer that includes a CPU and a memory. Then, the ECU 10 receives outputs (an engine load of the internal combustion engine 1 and data about a pressure and the like in the combustion chamber 21) of various kinds of sensors included in the internal combustion engine 1. The ECU 10 controls operations of the fuel supply unit 30, the ignition devices 40, the ion current detection circuits 50, the alternator 60, and respective parts of the internal combustion engine 1 in accordance with the received data.

In each of the three cylinders 20, the combustion chamber 21 that is an internal space is provided, and the piston 22 for compressing a fuel-containing gaseous mixture in the combustion chamber 21 is placed. The combustion chamber 21 forms a space for burning a fuel supplied from the fuel supply unit 30. The fuel is burned and exploded in the combustion chamber 21, which causes the piston 22 to move upward and downward, to thereby generate driving force.

Further, each of the three cylinders 20 is connected to an intake pipe 23 and an exhaust pipe 25. At a junction between the intake pipe 23 and the cylinder 20, the intake valve 24 is provided. When the piston 22 moves downward with the intake valve 24 opened, a fuel-containing gaseous mixture is supplied from the intake pipe 23 to the combustion chamber 21. At a junction between the exhaust pipe 25 and the combustion chamber 21, the exhaust valve 26 is provided. When the piston 22 moves upward with the exhaust valve 26 opened, exhaust gas in the combustion chamber 21 is released to the exhaust pipe 25. Meanwhile, when the piston 22 moves upward with the intake valve 24 and the exhaust valve 26 closed, a fuel-containing gaseous mixture in the combustion chamber 21 is compressed. Note that, in the present embodiment, as shown in FIG. 8, a flowmeter 27 for detecting a flow rate of air flowing through the intake pipe 23 and a throttle valve 28 for regulating a flow rate of air flowing through the intake pipe 23 are further interposed in the intake pipe 23.

The fuel supply unit 30 includes a first gaseous-fuel tank 31, a second gaseous-fuel tank 32, a mixer 33, and three injectors 34.

The first gaseous-fuel tank 31 is a reservoir in which ammonia gas (ammonia) is stored. The ammonia gas in the first gaseous-fuel tank 31 is supplied to the mixer 33 via a first supply pipe 311. Further, a first gas flowmeter 312 for measuring a flow rate of ammonia gas flowing through the first supply pipe 311 is interposed in the first supply pipe 311.

The second gaseous-fuel tank 32 is a reservoir in which hydrogen gas (hydrogen) generated by reforming of ammonia gas using a reformer not shown is stored. The hydrogen gas in the second gaseous-fuel tank 32 is supplied to the mixer 33 via a second supply pipe 321. Further, a second gas flowmeter 322 for measuring a flow rate of hydrogen gas flowing through the second supply pipe 321 is interposed in the second supply pipe 321.

The mixer 33 includes a mixing chamber 330, a first fuel valve 313, and a second fuel valve 323. The mixing chamber 330 forms a space for mixing ammonia gas supplied from the first gaseous-fuel tank 31 and hydrogen gas supplied from the second gaseous-fuel tank 32. The mixing chamber 330 is connected to a downstream end of the first supply pipe 311 and to a downstream end of the second supply pipe 321.

The first fuel valve 313 is a flow-rate regulating valve interposed at the downstream end of the first supply pipe 311. The first fuel valve 313 regulates a flow rate of ammonia gas supplied from the first gaseous-fuel tank 31 to the mixing chamber 330 in response to a first fuel supply signal output from the ECU 10.

The second fuel valve 323 is a flow-rate regulating valve interposed at the downstream end of the second supply pipe 321. The second fuel valve 323 regulates a flow rate of hydrogen gas supplied from the second gaseous-fuel tank 32 to the mixing chamber 330 in response to a second fuel supply signal output from the ECU 10.

A fuel mixture resulting from mixing ammonia gas and hydrogen gas in the mixing chamber 330 is supplied to each of the three injectors 34 via a fuel-mixture supply pipe 333.

The injector 34 is a device for supplying a fuel mixture to the combustion chamber 21 of each of the cylinders 20. The internal combustion engine 1 is a port-injection engine, and the injector 34 includes a fuel injection port abutting on the inside of the intake pipe 23. The injector 34 injects a fuel into the intake pipe 23 in response to a fuel injection signal output from the ECU 10, to thereby supply a fuel mixture into the combustion chamber 21. Note that the present invention is not limited thereto, and the injection port of the injector 34 may be placed in the combustion chamber 21. In other words, the internal combustion engine 1 may be a direct in-cylinder injection engine in which a fuel mixture is injected directly into the combustion chamber 21.

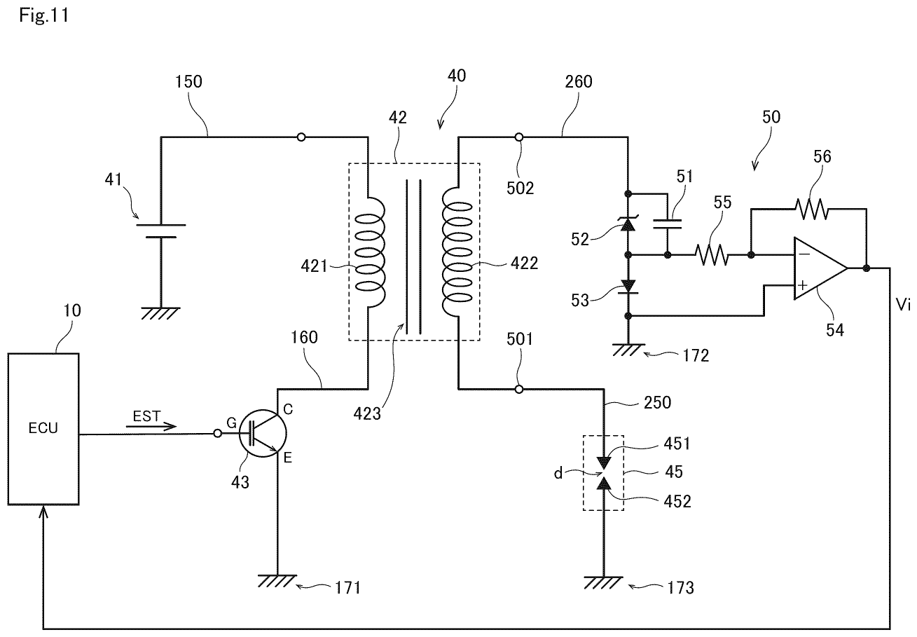

Each of the three ignition devices 40 is a device that applies a high voltage to a spark plug 45 placed in each of the cylinders 20 of the internal combustion engine 1, to produce spark discharge. FIG. 10 is a block diagram schematically showing an operating environment of one ignition device 40, and FIG. 11 is a block diagram schematically showing an operating environment of one ignition device 40 and one ion current detection circuit 50. As shown in FIG. 10 and FIG. 11, the ignition device 40 includes a power supply device 41 (battery), an ignition coil 42, an igniter 43, and the spark plug 45. Note that, in FIG. 11, a primary coil 421 and a secondary coil 422 described later are placed adjacently to each other, but the present invention is not limited thereto. The primary coil 421 and the secondary coil 422 may be placed in a direction in which the coils are stacked on each other.

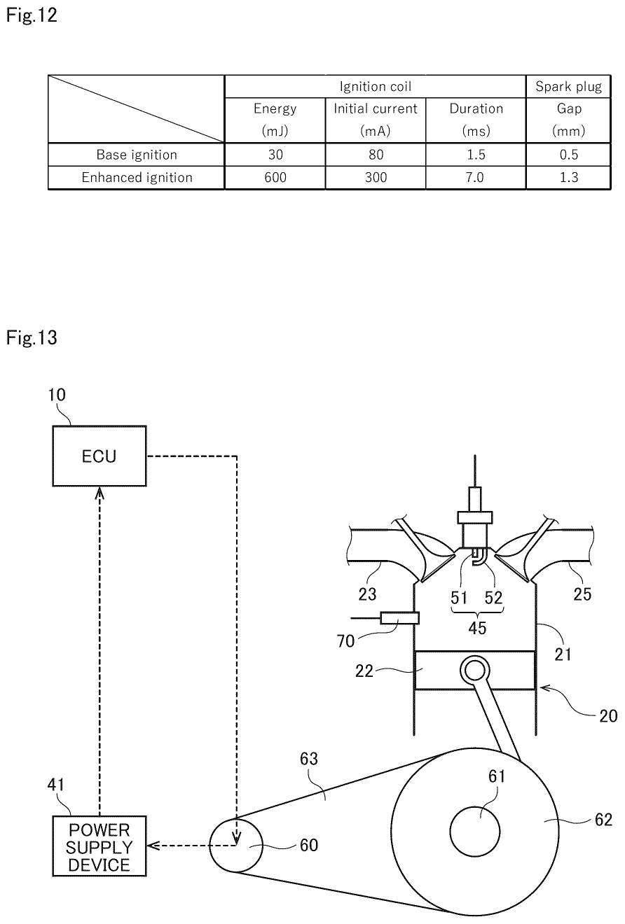

The ignition coil 42 is a unit for inducing a high voltage in the spark plug 45. In the present embodiment, as the ignition coil 42 and the spark plug 45, a system that corresponds to the above-described “base ignition system” and has specifications described as “Base ignition” in FIG. 12, and a system that corresponds to the “enhanced ignition system” and has specifications described as “Enhanced ignition” in FIG. 12, are prepared in advance. Note that, in FIG. 12, the term “Energy” means “total discharge energy provided by the spark plug 45 (a total amount of energy of discharge in the spark plug 45) in one cycle including stages from a compression stroke to an expansion stroke in the combustion chamber 21 of one cylinder 20” (hereinafter also simply referred to as “discharge energy”), the term “Initial current” means a “value of a secondary current flowing through the secondary coil 422 at the start of discharge), and the term “Duration” means a “total discharge period of the spark plug 45 (a sum of time periods in which discharge occurs in the spark plug 45) in one cycle including stages from a compression stroke to an expansion stroke in the combustion chamber 21 of one cylinder 20” (hereinafter also simply referred to as a “discharge period”), and the term “Gap” means a “gap d of the spark plug 45”.

Further, as shown in FIG. 10, the “enhanced ignition system” is implemented by use of a plurality of (six in the present embodiment) ignition coils 42. Then, the ignition coils 42 are arranged so as to be each connected in series to one spark plug 45 and be connected in parallel with each other. Note that, in FIG. 11, for the sake of ease in description, only one ignition coil 42 connected to one spark plug 45 is shown.

As shown in FIG. 11, the ignition coil 42 includes the primary coil 421, the secondary coil 422, and an iron core 423. The ignition coil 42 is formed by electromagnetic coupling of the primary coil 421 and the secondary coil 422 via the iron core 423. The number of turns of the secondary coil 422 is larger than the number of turns of the primary coil 421. Note that the specifications of the ignition coil 42 of the above-described “base ignition system” and the specifications of the ignition coil 42 of the “enhanced ignition system” may be implemented by a change in characteristics such as a value of a secondary voltage, made by a change in a ratio of the number of turns of the secondary coil 422 to the number of turns of the primary coil 421.

One end of the primary coil 421 is electrically connected to the power supply device 41 via a power supply line 150. The other end of the primary coil 421 is connected to ground 171 via a first ground wire 160. In the first ground wire 160, the igniter 43 is interposed.

The secondary coil 422 includes a high-voltage terminal 501 and a low-voltage terminal 502 at both ends thereof. One end of the secondary coil 422 is electrically connected to a center electrode 451 described later in the spark plug 45 via a connecting wire 250 connected to the high-voltage terminal 501. The other end of the secondary coil 422 is connected to ground 172 via a second ground wire 260 connected to the low-voltage terminal 502. Meanwhile, in the second ground wire 260, a part of the ion current detection circuit 50 is interposed.

The power supply device 41 is a direct-current chargeable/dischargeable storage battery. The power supply device 41 is electrically connected to the one end of the primary coil 421 of the ignition coil 42 via the power supply line 150. The power supply device 41 applies a direct-current voltage to the one end of the primary coil 421 via the power supply line 150. Note that the power supply device 41 may be allowed to make selections from a plurality of power supply voltages. To this end, the power supply device 41 is only required to be configured so as to output one power supply voltage selected from a plurality of power supply voltages by the ECU 10. Possible methods for changing a power supply voltage include, for example, a method in which a voltage is changed using a regulator of the alternator 60, a method in which storage batteries of different voltages are switched from one to another and used, and the like.

The igniter 43 is a semiconductor device that performs switching between ON and OFF for passage of a current from the power supply device 41 to the primary coil 421. For the igniter 43, for example, an insulated gate bipolar transistor (IGBT) is used. A collector (C) of the igniter 43 is electrically connected to the other end of the primary coil 421. An emitter (E) of the igniter 43 is connected to the ground 171. A gate (G) of the igniter 43 is electrically connected to the ECU 10. The igniter 43 turns ON/OFF and controls energization of the primary coil 421 in response to an EST signal that is an ignition signal provided from the ECU 10.

The spark plug 45 is a device that is placed in the combustion chamber 21 and performs an ignition operation in the combustion chamber 21. The spark plug 45 includes the center electrode 451 and a ground electrode 452 paired with the center electrode 451. The center electrode 451 is electrically connected to the high-voltage terminal 501 provided at the one end of the secondary coil 422 via the connecting wire 250. The ground electrode 452 in an engine block is connected to ground 173 via the cylinder 20.

When a high voltage is induced at the high-voltage terminal 501 of the secondary coil 422 and the high voltage exceeds a dielectric breakdown voltage at the gap d between the center electrode 451 and the ground electrode 452 of the spark plug 45, discharge occurs at the gap d, and spark is generated. Thus, a fuel supplied to the combustion chamber 21 is ignited.

Note that, in the present embodiment, the gap d between the center electrode 451 and the ground electrode 452 of the spark plug 45 used in the above-described “base ignition system” is “0.5 mm”. Meanwhile, the gap d between the center electrode 451 and the ground electrode 452 of the spark plug 45 used in the “enhanced ignition system” is “1.3 mm”. However, the gap d between the center electrode 451 and the ground electrode 452 of the spark plug 45 used in the “enhanced ignition system” is only required to be approximately “1.2 mm or larger and 1.4 mm or smaller”.

The ion current detection circuit 50 is a device for detecting an ion current flowing through a detection probe placed in the combustion chamber 21. In the present embodiment, the spark plug 45 is used as the detection probe for detecting an ion current. Alternatively, the ion current detection circuit 50 may include a detection probe separate from the spark plug 45. The ion current detection circuit 50 includes a capacitor 51, a Zener diode 52, a diode 53, an operational amplifier 54, a first resistor 55, and a second resistor 56.

The low-voltage terminal 502 of the secondary coil 422 is connected to a cathode of the Zener diode 52. An anode of the Zener diode 52 is connected to an anode of the diode 53. A cathode of the diode 53 is connected to the ground 172. Meanwhile, the capacitor 51 is connected in parallel with the Zener diode 52. The capacitor 51 generates a bias voltage.

An inverted-input terminal of the operational amplifier 54 is connected to a junction between the anode of the Zener diode 52 and the capacitor 51 via the first resistor 55. A noninverted-input terminal of the operational amplifier 54 is connected to the ground 172. Further, the inverted-input terminal and an output terminal of the operational amplifier 54 are connected to each other via the second resistor 56. Thus, the output terminal of the operational amplifier 54 provides a potential of a voltage value Vi proportional to a current value of an ion current flowing through the gap d of the spark plug 45. The output terminal of the operational amplifier 54 is connected to the ECU 10. That is, the ECU 10 receives the voltage value Vi proportional to a current value of an ion current, from the ion current detection circuit 50.

FIG. 13 is a block diagram schematically showing an operating environment in the vicinity of the alternator 60 of the internal combustion engine 1. As shown in FIG. 13, one end of a crank shaft 61 is fixed to the piston 22. The crank shaft 61 rotates along with vertical reciprocation of the piston 22. Further, the other end of the crank shaft 61 is connected to a crank pulley 62. The crank pulley 62 is connected to the alternator 60 (power generator) via a belt 63 that transmits rotation of the crank pulley 62. Moreover, the alternator 60 is electrically connected to the above-described power supply device 41 that is a storage battery.

The alternator 60 is a device that is driven to rotate along with vertical reciprocation of the piston 22 that reciprocates over a period of time from a compression stroke to an expansion stroke in the combustion chamber 21, to generate power. The power supply device 41 electrically connected to the alternator 60 can be charged up by power generation by the alternator 60.

The pressure sensor 70 is a device for measuring a pressure of a fuel-containing gaseous mixture in the combustion chamber 21. A shown in FIG. 8, the pressure sensor 70 is attached to the cylinder 20. A signal Pc associated with a measured value of a pressure in the combustion chamber 21, obtained by the pressure sensor 70, is amplified by an amplifier 71 electrically connected to the pressure sensor 70 and is input to the ECU 10.

### <2. Operations of Internal Combustion Engine>

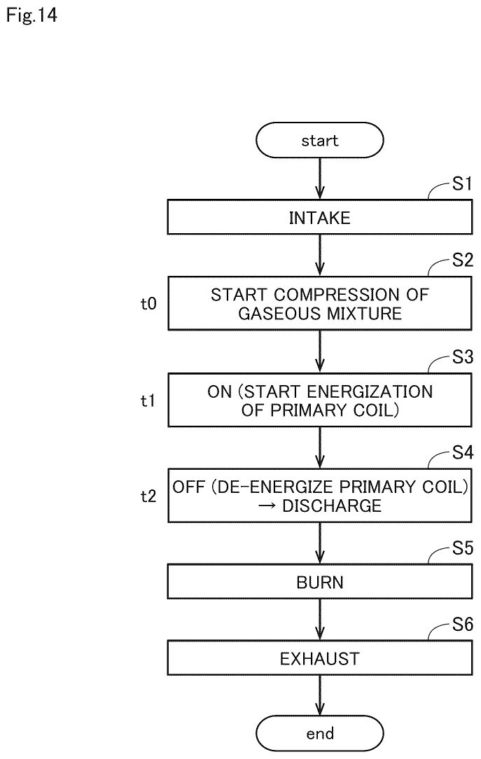

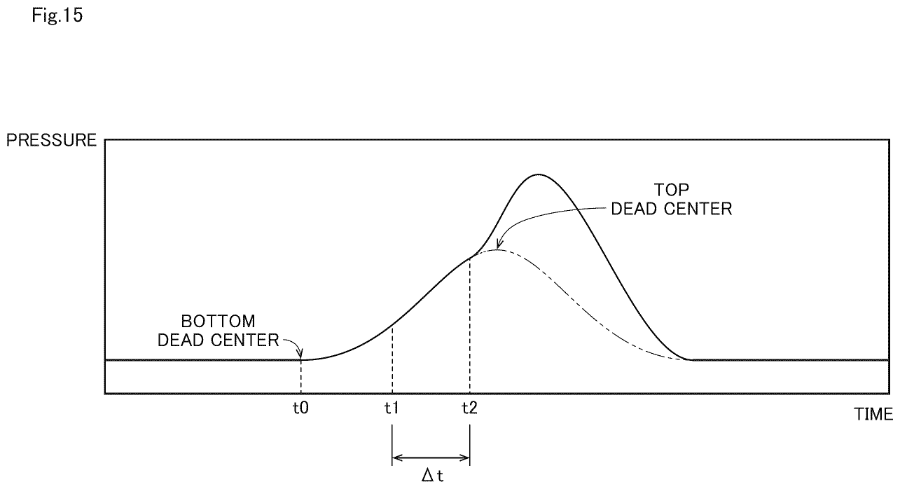

Next, operations of the internal combustion engine 1 are described. FIG. 14 is a flowchart showing a flow of operations of the internal combustion engine 1. FIG. 15 shows data resulting from measurement using the pressures sensor 70, indicating change with time of a pressure in the combustion chamber 21 during the operations shown in FIG. 14, in a case in which enhancement of ignition energy and contrivance to the ignition method described later are not applied. A horizontal axis in FIG. 15 represents time. A vertical axis in FIG. 15 represents a pressure in the combustion chamber 21.

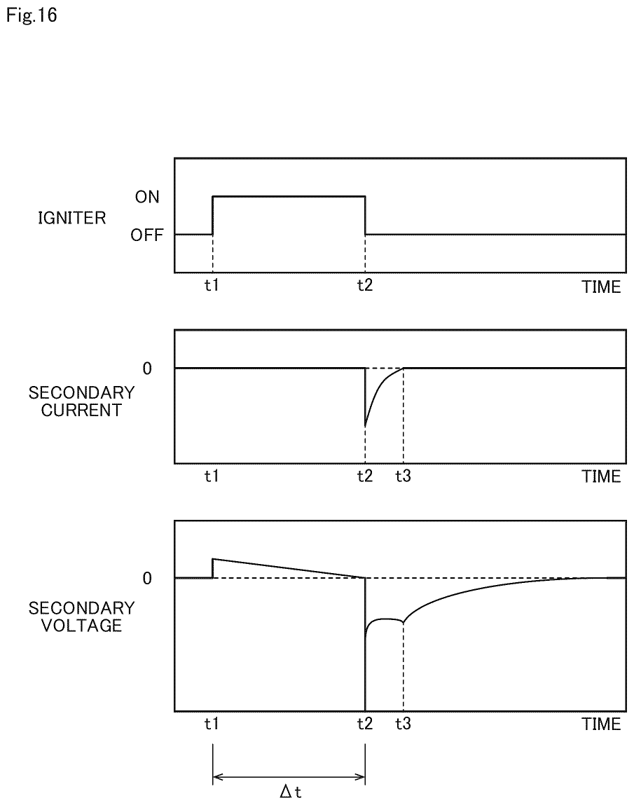

Further, FIG. 16 shows an ON/OFF state of the igniter 43 and change with time of a secondary current and a secondary voltage during operations in steps S2 to S5 in FIG. 14. The secondary current is a current flowing through the secondary coil 422. The secondary voltage is a voltage applied to the high-voltage terminal 501 at one end (closer to the spark plug 45) of the secondary coil 422.

The internal combustion engine 1 repeatedly performs operations in steps S1 to S6 in FIG. 14. In a case in which the internal combustion engine 1 is a four-stroke cycle engine, the piston 22 reciprocates twice during the operations in the steps S1 to S6 in FIG. 14 in each of the three cylinders 20. Specifically, the piston 22 reciprocates once during the steps S2 to S5 in FIG. 14, and the piston 22 reciprocates once during the steps S6 to S1.

The internal combustion engine 1, first, opens the intake valve 24 and causes the piston 22 to move from a TDC (top dead center) to a BDC (bottom dead center). Thus, a fuel-containing gaseous mixture is supplied to the combustion chamber 21 via the intake pipe 23 (step S1). Subsequently, at a time t0, the piston 22 starts to move from the BDC (bottom dead center) toward the TDC (top dead center). Then, the internal combustion engine 1 closes the intake valve 24. Thus, the fuel-containing gaseous mixture starts to be compressed (step S2).

Subsequently, the internal combustion engine 1 starts energization at a timing calculated back from an energization-time ignition timing at which desired ignition energy can be supplied. Specifically, the igniter 43 is changed from OFF (open state) to ON (closed state) in response to an EST signal provided from the ECU 10 (step S3). As a result, a primary current flows from the power supply device 41 to the ground 171 via the power supply line 150, the primary coil 421, and the first ground wire 160. Thus, primary energy is stored in the ignition coil 42. In other words, the internal combustion engine 1 first performs charge control in which a primary current is caused to flow through the primary coil 421, to perform charge.

After that, at a time t2, the igniter 43 is changed from ON (closed state) to OFF (open state) in response to an EST signal provided from the ECU 10 (step S4). As a result, the primary coil 421 is de-energized. Then, induced electromotive force is produced in the secondary coil 422 via the iron core 423, and a high voltage corresponding to the above-described primary energy is generated in the secondary coil 422. The induced electromotive force is positive or negative depending on a direction of winding of the secondary coil 422, but in the present embodiment, it is assumed that a high voltage across the other end (the low-voltage terminal 502) labeled as positive and the one end (the high-voltage terminal 501) labeled as negative is generated in the secondary coil 422.

When the high voltage is generated in the secondary coil 422, a high voltage is generated also across the center electrode 451 and the ground electrode 452 of the spark plug 45. Specifically, a voltage value of the center electrode 451 becomes equal to minus several thousands of volts to minus several tens of thousands of volts with respect to a voltage value (ground voltage) of the ground electrode 452. Then, due to the high voltage, dielectric breakdown takes place across the center electrode 451 and the ground electrode 452 of the spark plug 45, so that spark discharge occurs between the two electrodes. By this spark, a fuel supplied to the combustion chamber 21 of the internal combustion engine 1 is burned (step S5). More specifically, by this spark, an initial flame kernel (a small ball of flame formed initially) is generated in a fuel-containing gaseous mixture around the spark plug 45, and heat or the like of the flame kernel is transferred to the surrounding fuel-containing gaseous mixture, so that the flame propagates and combustion spreads to the entire fuel-containing gaseous mixture.

In other words, after the above-described charge control, the internal combustion engine 1 interrupts a primary current flowing through the primary coil 421 and induces a high voltage at the one end of the secondary coil 422, to thereby perform discharge control in which discharge is caused to occur in the spark plug 45 in the combustion chamber 21 of each of the cylinders 20.

Referring to FIG. 16, in a time period from the time t2 to the time t3, discharge occurs in the spark plug 45. At that time, due to the dielectric breakdown across the center electrode 451 and the ground electrode 452, a secondary current flows from the ground 173 to the second ground wire 260 via the ground electrode 452, the center electrode 451, the connecting wire 250, and the secondary coil 422.

When the fuel in the combustion chamber 21 is burned, a pressure in the combustion chamber 21 increases, and the piston 22 moves from the TDC (top dead center) to the BDC (bottom dead center). After that, the internal combustion engine 1 opens the exhaust valve 26. Then, the piston 22 moves from the BDC (bottom dead center) to the TDC (top dead center). Thus, the burned gas in the combustion chamber 21 is released to the exhaust pipe 25 (step S6). Note that FIG. 15 shows change with time of a pressure in the combustion chamber 21 in a case in which the primary coil 421 starts to be energized at a time t1 at which the pressure in the combustion chamber 21 is in a process of increasing, and the primary coil 421 is de-energized at the time t2 before a time at which the piston 22 reaches the TDC (top dead center).

### <3. Enhancement of Ignition Energy and Contrivance to Ignition Method>

Now, a method for improving combustibility of a fuel containing ammonia while reducing an amount of use of hydrogen as a combustion improver by enhancement of ignition energy and contrivance to an ignition method is described in detail.

### <3-1. Increase in Amount of Discharge Energy of Spark Plug>

First, description is given about an ignition method in which total discharge energy provided by the spark plug 45 is set to 600 mJ or more by using the ignition coil 42 and the spark plug 45 of the above-described “enhanced ignition system”. Specifically, according to the ignition method, a gaseous fuel containing ammonia and hydrogen supplied to the combustion chamber 21 is ignited by discharge produced by the spark plug 45 of the ignition device 40, and total discharge energy provided by the spark plug 45 in one cycle including stages from a compression stroke to an expansion stroke in the combustion chamber 21 of one cylinder 20 is set to 600 mJ or more.

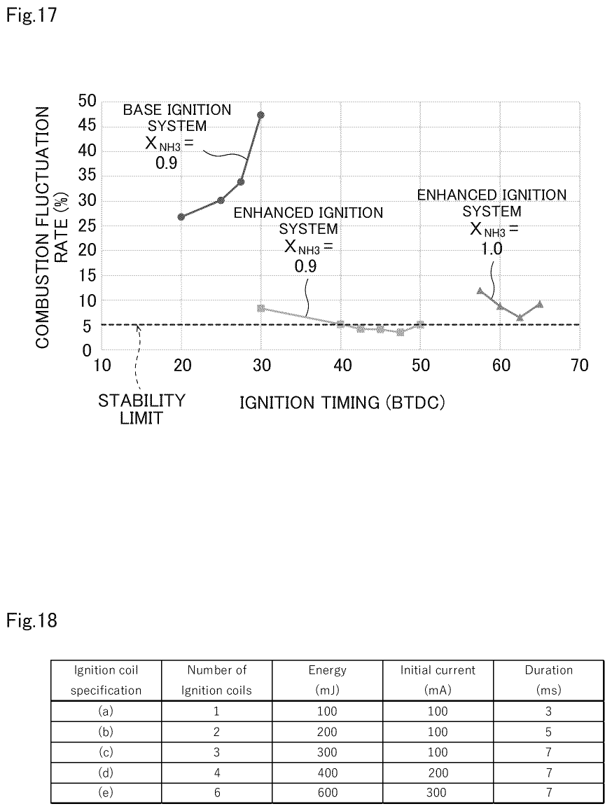

FIG. 17 shows results of measuring a combustion fluctuation rate during combustion of a fuel mixture of ammonia and hydrogen in each of cases in which total discharge energy provided by the spark plug 45 is set to 600 mJ using the “enhanced ignition system” and in which total discharge energy provided by the spark plug 45 is set to 30 mJ using the “base ignition system”. Note that the measurement is performed under conditions where no load is applied to the internal combustion engine 1, the number of revolutions is 1,000 rpm, and an equivalent ratio (a value obtained by division of a theoretical air-fuel ratio by an actual air-fuel ratio) is 1.0. Meanwhile, a mixing ratio X_{NH3} of ammonia (a mole fraction of ammonia in the fuel mixture of ammonia and hydrogen) is set to “0.9”, and further, measurement for a case in which the mixing ratio X_{NH3} of ammonia is “1.0” (a case in which the “enhanced ignition system” is used) is also performed for comparative verification.

Meanwhile, in FIG. 17, a horizontal axis represents an ignition timing (a timing of ignition in the spark plug 45, corresponding to a crank angle before the TDC (top dead center)) in the internal combustion engine 1. A vertical axis represents a combustion fluctuation rate. As shown in FIG. 17, it is found that, when the total discharge energy provided by the spark plug 45 is set to 600 mJ using the “enhanced ignition system”, an increase in the combustion fluctuation rate due to advance of the ignition timing is not seen, and that advancing the ignition timing to 400 BTDC or earlier makes the combustion fluctuation rate equal to or lower than the stability limit (approximately 5%). Moreover, it is found that the combustion fluctuation rate can be reduced to a value close to the stability limit (approximately 5%) also in a case in which the mixing ratio X_{NH3} of ammonia is “1.0”.

Further, the total discharge energy provided by the spark plug 45 and a secondary current value of the ignition coil 42 are changed to various values shown in (a) to (e) in FIG. 18, and the influence upon the combustion fluctuation rate is checked. Note that the specifications shown in (a) to (e) in FIG. 18 are implemented by connection of a plurality of ignition coils 42 in parallel with each other as shown in FIG. 10 described above. Meanwhile, in (a) to (e) in FIG. 18, the term “Number of Ignition coils” means “the number of the ignition coils 42 connected in parallel”, the term “Energy” means “total discharge energy provided by the spark plug 45 in one cycle including stages from a compression stroke to an expansion stroke in the combustion chamber 21 of one cylinder 20”, the term “initial current” means a “value of a secondary current flowing through the secondary coil 422 at the start of discharge”, and the term “Duration” means a “total discharge period of the spark plug 45 in one cycle including stages from a compression stroke to an expansion stroke in the combustion chamber 21 of one cylinder 20”.

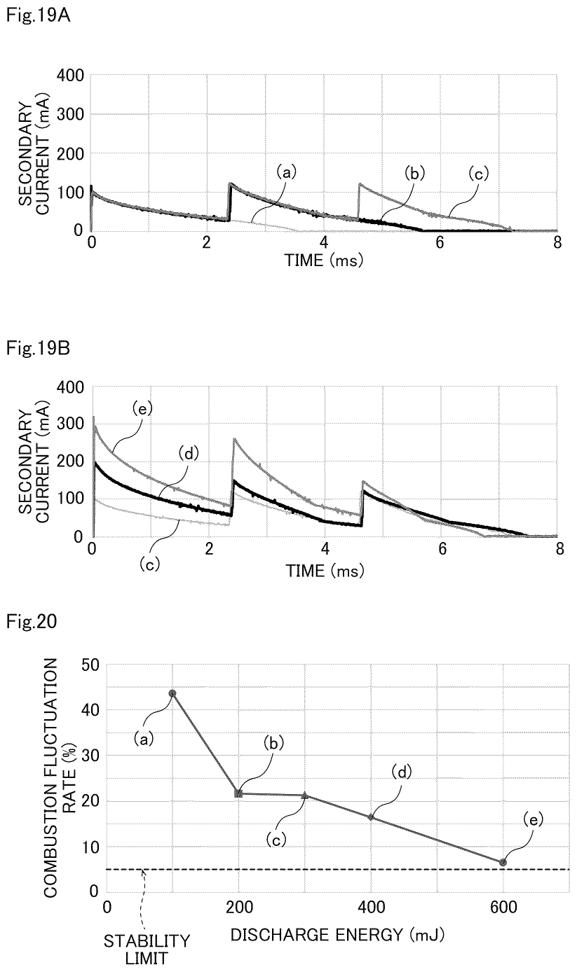

Note that the measurement is performed under conditions where no load is applied to the internal combustion engine 1, the number of revolutions is 1,000 rpm, an equivalent ratio is 1.0, and the mixing ratio X_{NH3} of ammonia is “1.0”, and the gap d of the spark plug 45 is “1.3 mm”. FIG. 19A and FIG. 19B show change with time of a value of a secondary current flowing through the secondary coil 422 in each of cases in which the values in (a) to (e) in FIG. 18 are used, respectively, and FIG. 20 shows results of measuring a combustion fluctuation rate in each of cases in which the values in (a) to (e) in FIG. 18 are used, respectively.

As shown in FIG. 20, it is found that, according to the specifications shown in (e) in FIG. 18, specifically, when the value of the secondary current flowing through the secondary coil 422 at the start of discharge is set to 300 mA or more and the total discharge energy provided by the spark plug 45 is set to 600 mJ or more, the combustion fluctuation rate is at the stability limit (approximately 5%) or lower. In other words, it is found that it is preferred that the value of the secondary current flowing through the secondary coil 422 at the start of discharge be 300 mA or more (200 mA or more, at minimum), in discharge control, as the method for enhancing ignition energy.

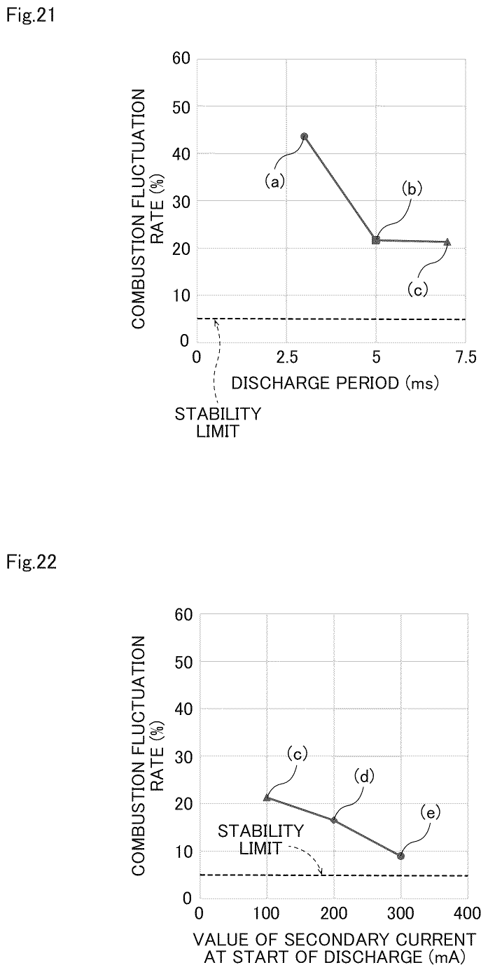

Further, in addition to the above-described measurement using the ignition systems having the values in (a) to (e) in FIG. 18, a relation between a discharge period of the spark plug 45 and a combustion fluctuation rate and a relation between a value of a secondary current flowing through the secondary coil 422 at the start of discharge and a combustion fluctuation rate are checked. Results thereof are shown in FIG. 21 and FIG. 22. As shown in FIG. 22, it is found that the larger the value of the secondary current at the start of discharge is, the lower the combustion fluctuation rate is.

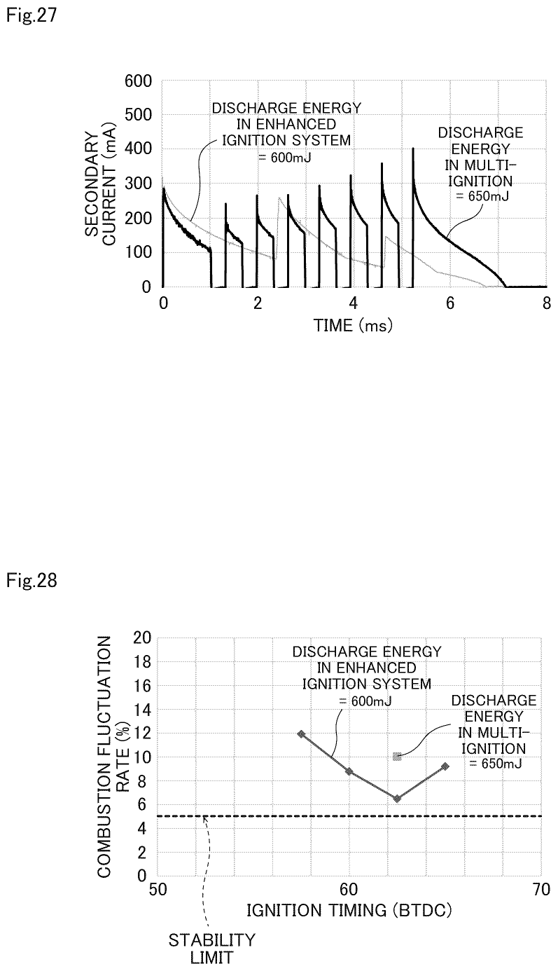

However, as shown in FIG. 27 regarding results of measurement on “multi-ignition” described later, it is revealed that, in a case in which the value of the secondary current at the start of discharge is approximately 300 mA, the value of the secondary current decreases to approximately 200 mA after a lapse of 0.3 ms. Hence, it is preferred that a period of 0.3 ms or longer in one cycle be secured as a period in which the value of the secondary current flowing through the secondary coil 422 is 200 mA or more, in discharge control, as the method for enhancing ignition energy.

Further, as shown in the above-described results of measurement in FIG. 2, it is found that the combustion fluctuation rate is at the stability limit (approximately 5%) or lower in a case in which an ignition timing (crank angle before the TDC (top dead center)) in one cycle of one cylinder 20 is approximately 200 BTDC or later. Moreover, considering the combustion periods of the fuels shown in FIG. 5, it is preferred that discharge be caused to occur in the spark plug 45 over a period of time from a starting point that is advanced relative to the top dead center by more than 20°, to 20° BTDC or later (more preferably, to the TDC (top dead center)), in one cycle, for discharge control, as the contrivance to the ignition method.

Meanwhile, also while discharge is occurring in the spark plug 45, a flow of the fuel-containing gaseous mixture is generated in the combustion chamber 21. Hence, when the value of the secondary current becomes excessively small, spark generated at the gap d of the spark plug 45 is liable to be blown out due to the flow of the gaseous mixture. Thus, in order to suppress this phenomenon, it is required to keep the secondary current at a certain value. Then, from empirical values and the like, it is made clear that the spark at the gap d of the spark plug 45 is maintained without being blown out when the value of the secondary current is approximately 50 mA or more.

In view of this, as the method for enhancing ignition energy, it is preferred that the value of the secondary current flowing through the secondary coil 422 be kept at 50 mA or more (more preferably, 100 mA or more) over a period of time from a starting point that is advanced relative to the top dead center by more than 20°, to 200 BTDC or later, in one cycle of one cylinder 20, for discharge control.

### <3-2. Change in Gap of Spark Plug>

Next, description is given about a method for setting the gap d of the spark plug 45 to approximately “1.3 mm” by using the spark plug 45 of the above-described “enhanced ignition system”.

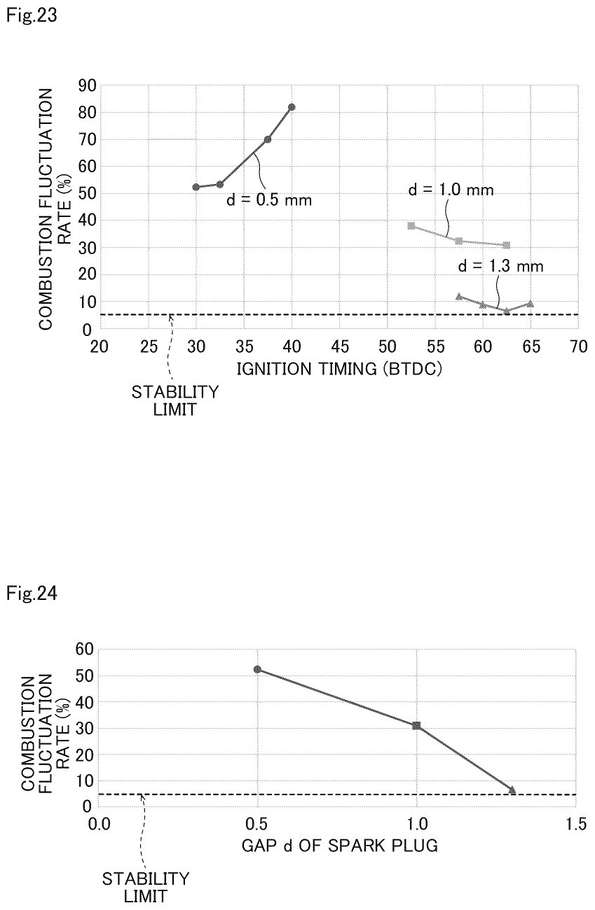

FIG. 23 shows results of measuring a combustion fluctuation rate during combustion of a fuel in each of cases in which the gap d of the spark plug 45 is set to three variations of “0.5 mm”, “1.0 mm”, and “1.3 mm”, respectively. Note that the measurement is performed under conditions where no load is applied to the internal combustion engine 1, the number of revolutions is 1,000 rpm, an equivalent ratio is 1.0, the mixing ratio X_{NH3} of ammonia is “1.0”, and total discharge energy provided by the spark plug 45 is 600 mJ. A horizontal axis represents an ignition timing (crank angle before the TDC (top dead center)). A vertical axis represents a combustion fluctuation rate.

As shown in FIG. 23, it is found that the combustion fluctuation rate increases as the gap d becomes narrower, and that the combustion fluctuation rate significantly increases as the ignition timing is more advanced in a case in which the gap d is “0.5”. However, from empirical values and the like, it is found that discharge does not properly occur in a case in which the gap d is wider than “1.3 mm”.

FIG. 24 shows results of measuring a combustion fluctuation rate at an optimal ignition timing in each of cases in which the gap d is set to three variations of “0.5 mm”, “1.0 mm”, and “1.3 mm”. As shown in FIG. 24, it is found that, in a case in which the gap d is “1.3 mm” or smaller, the combustion fluctuation rate decreases as the gap d becomes wider.

From those results, it can be considered that, even under conditions where it is difficult to ignite, specifically, under conditions where an ignition timing is advanced, a compression pressure in the combustion chamber 21 is low, and a temperature is low, widening the gap d of the spark plug 45 enables an increase in a volume of a fuel-containing gaseous mixture subjected to discharge, and securing a distance between an initial flame kernel and the electrodes 451 and 452 enables reduction in cooling loss of the electrodes 451 and 452. As described above, it is better to have a wider gap d of the spark plug 45 within a range in which a required voltage (a voltage at which discharge can occur at an in-cylinder pressure determined by a compression ratio) can be supplied, but it is preferred that the gap d be set to “1.2 mm or larger and 1.4 mm or smaller”. It can be considered that this setting enables reduction in a combustion fluctuation rate and more stable combustion of a fuel.

### <3-3. Change in Number of Revolutions and Load>

Next, a method for changing a load applied to the internal combustion engine 1 and the number of revolutions is described.

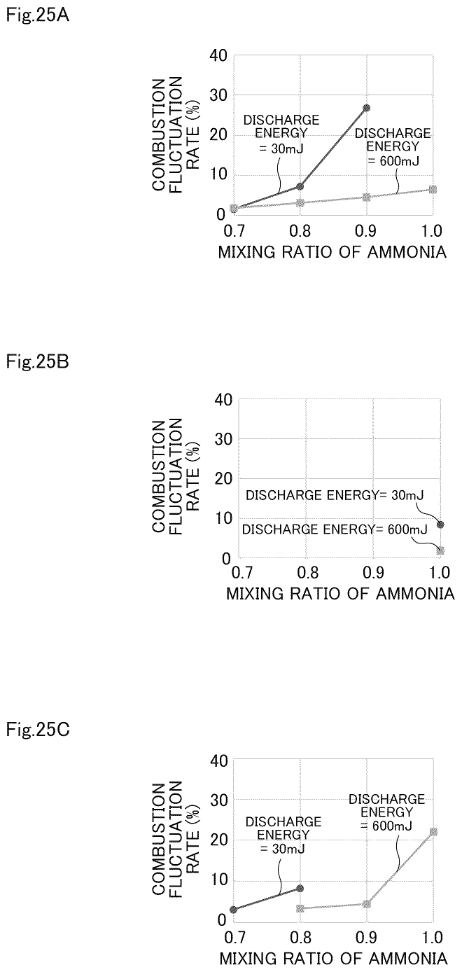

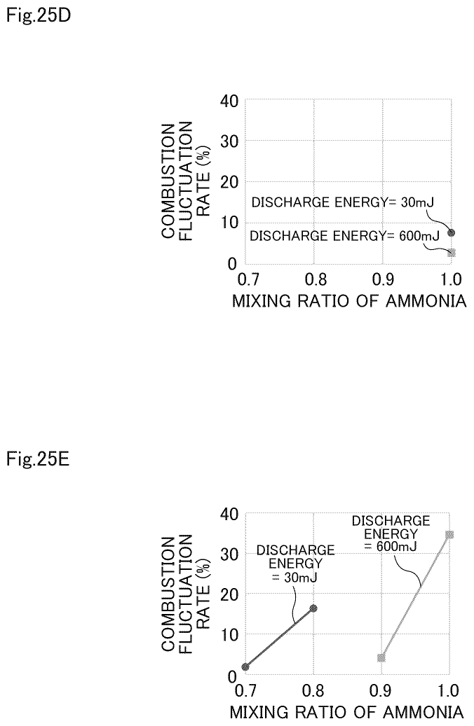

FIG. 25A to FIG. 25E show results of measuring a combustion fluctuation rate during combustion of a fuel in cases in which a load applied to the internal combustion engine 1 and the number of revolutions are changed to various values, respectively. More specifically, FIG. 25A shows results of measurement in a case in which no load is applied to the internal combustion engine, the number of revolutions is 1,000 rpm, and an indicated mean effective pressure is 140 kPa. FIG. 25B shows results of measurement in a case in which the number of revolutions is 1,000 rpm, and an indicated mean effective pressure is 400 kPa. FIG. 25C shows results of measurement in a case in which no load is applied to the internal combustion engine, the number of revolutions is 2,500 rpm, and an indicated mean effective pressure is 148 kPa. FIG. 25D shows results of measurement in a case in which the number of revolutions is 2,500 rpm, and an indicated mean effective pressure is 355 kPa. FIG. 25E shows results of measurement in a case in which no load is applied to the internal combustion engine, the number of revolutions is 4,000 rpm, and an indicated mean effective pressure is 184 kPa. Meanwhile, the measurement shown in FIG. 25A to FIG. 25E is performed with an equivalent ratio set to 1.0 and using a spark plug having a gap of “1.3 mm”. Further, ignition coils that allow the spark plugs 45 to provide discharge energy of 30 mJ and 600 mJ, respectively, are used.

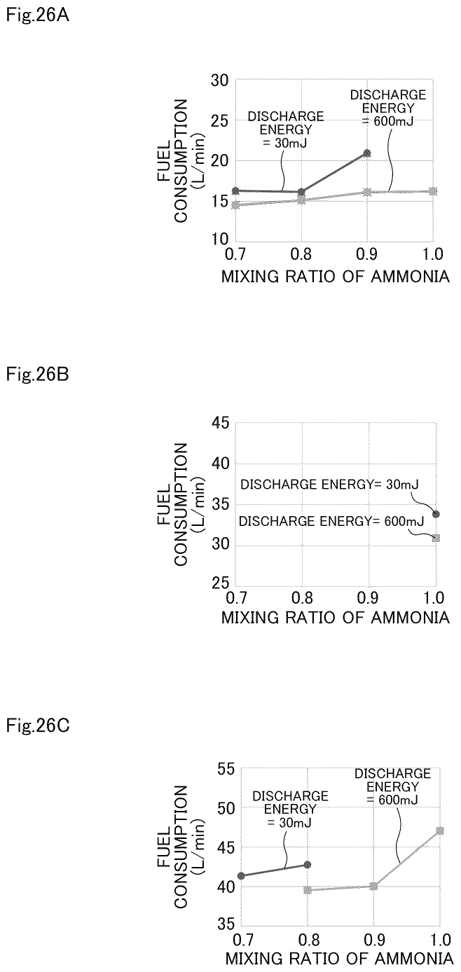

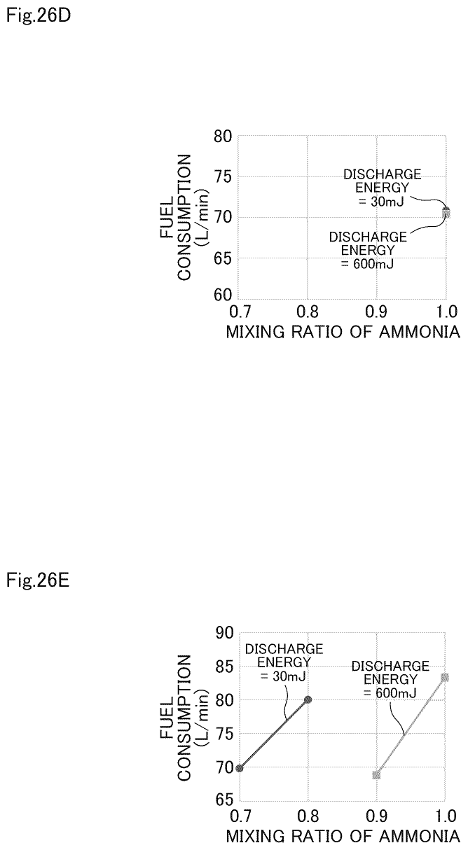

FIG. 26A to FIG. 26E show results of measuring fuel consumption during combustion of a fuel in cases in which a load applied to the internal combustion engine 1 and the number of revolutions are changed to various values, respectively. More specifically, FIG. 26A shows results of measurement in a case in which no load is applied to the internal combustion engine, the number of revolutions is 1,000 rpm, and an indicated mean effective pressure is 140 kPa. FIG. 26B shows results of measurement in a case in which the number of revolutions is 1,000 rpm, and an indicated mean effective pressure is 400 kPa. FIG. 26C shows results of measurement in a case in which no load is applied to the internal combustion engine, the number of revolutions is 2,500 rpm, and an indicated mean effective pressure is 148 kPa. FIG. 26D shows results of measurement in a case in which the number of revolutions is 2,500 rpm, and an indicated mean effective pressure is 355 kPa. FIG. 26E shows results of measurement in a case in which no load is applied to the internal combustion engine, the number of revolutions is 4,000 rpm, and an indicated mean effective pressure is 184 kPa. Meanwhile, the measurement shown in FIG. 26A to FIG. 26E is performed with an equivalent ratio set to 1.0 and using a spark plug having a gap of “1.3 mm”. Further, ignition coils that allow the spark plugs 45 to provide discharge energy of 30 mJ and 600 mJ, respectively, are used.

From the results shown in FIG. 25A to FIG. 25E and FIG. 26A to FIG. 26E, it is found that, when a load applied to the internal combustion engine 1 and the number of revolutions are increased and total discharge energy provided by the spark plug 45, in other words, ignition energy, is enhanced by using the above-described “enhanced ignition system”, the combustion fluctuation rate and the fuel consumption are generally reduced.

Thus, for example, it is conceivable to stabilize combustion by increasing a generated current of the alternator 60 in a case in which an engine load applied to the internal combustion engine 1 is low. In other words, it is conceivable to regulate combustion by controlling a generated current of the alternator 60 that generates power along with reciprocation of the piston 22 that reciprocates over a period of time from a compression stroke to an expansion stroke in the combustion chamber 21, as the contrivance to the ignition method. More specifically, it is conceivable to increase a generated current as an engine load to the internal combustion engine 1 decreases, and decrease a generated current as an engine load to the internal combustion engine 1 increases.

As described, a generated current of the alternator 60 is increased during a low-load (engine load) period, and thus a load applied to the internal combustion engine 1 by the alternator 60 is increased. Hence, in order to maintain the number of revolutions, the throttle valve 28 is opened to a greater extent in response to a control signal from the ECU 10, and a gaseous mixture containing a larger amount of fuel is supplied from the intake pipe 23 to the combustion chamber 21. This results in an increase in an intake pressure, leading to an increase in a pressure in the combustion chamber 21, so that combustibility of the fuel can be increased. On the other hand, during a high-load (engine load) period, it is possible to use a larger amount of energy produced by combustion of the fuel for a power side by reducing a load applied by the alternator 60.

<3-4. Multi-Ignition>

Next, description is given about a method in which approximately one to two existing small ignition coils 42 connected in parallel with each other and spark plugs 45 are used, the approximately one to two ignition coils 42 are charged up a plurality of times in one cycle including stages from a compression stroke to an expansion stroke in the combustion chamber 21 of one cylinder 20, and discharge is caused to occur in the spark plugs 45 a plurality of times. In other words, in the ignition method, charge control and discharge control are alternately repeated a plurality of times in one cycle, and, before the end of discharge performed as the first discharge control in the spark plug 45 in the one cycle, next charge control is performed. Meanwhile, in the ignition method, also in a case in which a plurality of the ignition coils 42 are used, those coils are simultaneously subjected to charge control and discharge control. Note that a period of time from a starting point of discharge in the spark plug 45 for discharge control to a starting point of next charge control in one cycle is not necessarily required to be constant. Further, the above-described ignition method may be applied to only a part of the approximately one to two ignition coils 42.

FIG. 27 shows results of measuring change with time of a value of a secondary current (a total value of secondary currents flowing through the secondary coils 422 of the approximately one to two ignition coils 42) in a case in which the above-described multi-ignition is performed. Note that the measurement is performed under conditions where no load is applied to the internal combustion engine 1, the number of revolutions is 1,000 rpm, an equivalent ratio is 1.0, the mixing ratio X_{NH3} of ammonia is “1.0”, and a spark plug having a gap of “1.3 mm” is used. Further, total discharge energy provided by the spark plugs 45 connected to the approximately one to two ignition coils 42 used in the multi-ignition in one cycle is 650 mJ. Moreover, a period of 0.3 ms or longer in one cycle is secured as a period in which a total value of secondary currents flowing through the secondary coils 422 of the approximately one to two ignition coils 42 is kept at 200 mA or more from the start of discharge. Note that FIG. 27 shows, for comparison, also results of similar measurement using the above-described “enhanced ignition system” in which total discharge energy provided by the spark plug 45 in one cycle is “600 mJ”.

As shown in FIG. 27, in a case in which the multi-ignition is performed, before all of energy stored in the ignition coil 42 for the first charge control is released for the first discharge control, next charge is performed, and thus a next charge period, that is, a period in which discharge does not occur, can be shortened. Further, it is found that a discharge current that is sufficient enough to bear comparison with that in the case in which the “enhanced ignition system” is used can be caused to intermittently flow.

FIG. 28 shows results of comparison of combustion fluctuation rates between a case in which the above-described multi-ignition is performed and a case in which ignition is performed using the enhanced ignition system. In FIG. 28, a horizontal axis represents an ignition timing (a timing of ignition in the spark plug 45, corresponding to a crank angle before the TDC (top dead center)). A vertical axis represents a combustion fluctuation rate.

As shown in FIG. 28, it is found that the substantially same combustion fluctuation rate as that in the case in which ignition is performed using the enhanced ignition system is obtained also in the case in which the multi-ignition is performed. Specifically, it is found that, in a case in which no load is applied to the internal combustion engine 1 and the mixing ratio X_{NH3} of ammonia is set to “1.0”, in other words, hydrogen is not used, the combustion fluctuation rate can be reduced, and a fuel can be stably burned.

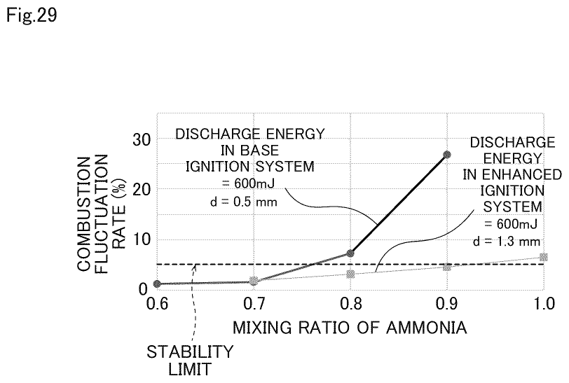

FIG. 29 shows results of measuring a combustion fluctuation rate during combustion of a fuel in a case in which the ignition coil 42 and the spark plug 45 of the “enhanced ignition system” are used, in comparison with a case in which an ignition system (having the substantially same specifications as those of the above-described base ignition system) mounted in an existing vehicle is used. Note that the measurement is performed under conditions where no load is applied to the internal combustion engine 1, the number of revolutions is 1,000 rpm, and an equivalent ratio is 1.0.

As shown in FIG. 29, in the ignition system (having the substantially same specifications as those of the above-described base ignition system) mounted in an existing vehicle, in a case in which no load is applied to the internal combustion engine 1, it is required to set the mixing ratio X_{NH3} of ammonia to “0.7” or lower, in other words, to mix as much as approximately 30% hydrogen, in order to achieve stable combustion. However, it is found that, even in a case in which the mixing ratio X_{NH3} of ammonia is increased to approximately “0.9”, by enhancing ignition energy using the “enhanced ignition system”, it is possible to keep the combustion fluctuation rate at the stability limit (approximately 5%) or lower and achieve stable combustion. In other words, it is found that the amount of use of hydrogen can be significantly reduced to approximately one third. Further, in a case in which a load is applied to the internal combustion engine 1, it has been made clear that stable combustion can be achieved even with a further increase in the mixing ratio X_{NH3} of ammonia, as described above, and thus it is expected to enable driving without use of hydrogen.

As described above, in the present invention, by enhancing ignition energy and applying contrivance to the ignition method, it is possible to improve combustibility of a fuel containing ammonia even in a region in which an engine load to the internal combustion engine 1 is low. This enables reduction of an amount of hydrogen used as a combustion improver.

### <4. Modifications>

Hereinabove, the embodiment of the present invention has been described, but the present invention is not limited to the above-described embodiment.

In the above-described embodiment, the piston 22 is configured so as to reciprocate in a predetermined positional range. Alternatively, the position of the top dead center of the piston 22 may be variable. Specifically, the ECU 10 may control the piston 22 that reciprocates over a period of time from a compression stroke to an expansion stroke in the combustion chamber 21 such that the position of the top dead center thereof is variable, to increase a compression ratio as an engine load to the internal combustion engine 1 decreases and decrease a compression ratio as an engine load to the internal combustion engine 1 increases.

Thus, the compression ratio is increased in the region in which an engine load to the internal combustion engine 1 is low, and thus a temperature of the fuel-containing gaseous mixture is increased, whereby the combustibility of the fuel can be increased. Further, by appropriately adjusting the compression ratio, it is possible to further stabilize combustion.

Further alternatively, a plurality of ignition devices 40 may be provided to burn a fuel in the combustion chamber 21 of one cylinder 20. In this regard, it is only required that a plurality of spark plugs 45 of the plurality of ignition devices 40 provide discharge energy of 600 mJ or more in total in one cycle. Then, the fuel may be ignited by simultaneous occurrence of discharge in the plurality of spark plugs 45 in the one cycle including stages from a compression stroke to an expansion stroke in the combustion chamber 21 of the one cylinder 20. Specifically, in the one cycle, discharge is caused to occur in the respective spark plugs 45 of the plurality of ignition devices 40 in the combustion chamber 21 of the one cylinder 20 at the same timing, for discharge control. Thus, the gaseous fuel containing ammonia supplied to the combustion chamber 21 of the one cylinder 20 may be ignited by discharge produced by the respective spark plugs 45 of the plurality of ignition devices 40.

Further alternatively, the mixing ratio of ammonia and hydrogen in the gaseous fuel supplied to the combustion chamber 21 may be adjusted on the basis of a result of detecting a pressure in the combustion chamber 21 using the pressure sensor 70 and a result of detection of an ion current flowing through the detection probe (spark plug 45) placed in the combustion chamber 21. For example, when reduction in a pressure in the combustion chamber 21 is detected, a mixing ratio of hydrogen that is more combustible may be increased. Moreover, an actual value of a mixing ratio of ammonia and hydrogen in the gaseous fuel in the combustion chamber 21 may be more accurately grasped on the basis of a result of detecting an ion current, and the mixing ratio of ammonia and hydrogen in the gaseous fuel supplied to the combustion chamber 21 may be appropriately adjusted. This enables more appropriate ignition.

Furthermore, a detailed shape of the internal combustion chamber may be different from that shown in each drawing of the present application. Further, the respective elements described in the above-described embodiment and modifications may be appropriately combined unless contradiction occurs.

### REFERENCE SIGNS LIST

1 Internal combustion engine
10 ECU
20 Cylinder
21 Combustion chamber
22 Piston
30 Fuel supply unit
40 Ignition device
41 Power supply device (battery)
42 Ignition coil
43 Igniter
45 Spark plug
50 Ion current detection circuit
60 Alternator
70 Pressure sensor
421 Primary coil (of ignition coil)
422 Secondary coil (of ignition coil)
451 Center electrode (of spark plug)
452 Ground electrode (of spark plug)
d Gap (of spark plug)

1. An ignition method for an internal combustion engine in which a gaseous fuel containing ammonia and hydrogen supplied to a combustion chamber is ignited by discharge produced by a spark plug of an ignition device, wherein total discharge energy provided by the spark plug in one cycle including stages from a compression stroke to an expansion stroke in the combustion chamber of one cylinder is 600 mJ or more.

2. The ignition method according to claim 1, wherein, using an ignition coil formed by electromagnetic coupling of a primary coil and a secondary coil connected to the spark plug in the ignition device, charge control in which a primary current is caused to flow through the primary coil to perform charge, and discharge control in which the primary current flowing through the primary coil is interrupted after the charge control and a high voltage is induced at one end of the secondary coil, to cause discharge to occur in the spark plug in the combustion chamber of the one cylinder, are performed.

3. The ignition method according to claim 2, wherein a value of a secondary current flowing through the secondary coil at start of discharge is 200 mA or more in the discharge control.

4. The ignition method according to claim 3, wherein a period of 0.3 ms or longer in the one cycle is secured as a period in which the value of the secondary current flowing through the secondary coil is 200 mA or more in the discharge control.

5. The ignition method according to claim 3, wherein the value of the secondary current flowing through the secondary coil at start of discharge is 300 mA or more in the discharge control.

6. The ignition method according to claim 2, wherein discharge is caused to occur in the spark plug over a period of time from a starting point that is advanced relative to a top dead center by more than 20°, to 20° BTDC or later, in the one cycle, for the discharge control.

7. The ignition method according to claim 6, wherein discharge is caused to occur in the spark plug over a period of time from the starting point that is advanced relative to the top dead center by more than 20°, to the TDC, in the one cycle, for the discharge control.

8. The ignition method according to claim 6, a value of a secondary current flowing through the secondary coil is kept at 50 mA or more over the period of time from the starting point that is advanced relative to the top dead center by more than 20°, to 20° BTDC or later, in the one cycle, for the discharge control.

9. The ignition method according to claim 8, wherein the value of the secondary current flowing through the secondary coil is kept at 100 mA or more over the period of time from the starting point that is advanced relative to the top dead center by more than 20°, to 20° BTDC or later, in the one cycle, for the discharge control.

10. The ignition method according to claim 1, wherein a gap between a center electrode of the spark plug and a ground electrode paired with the center electrode is preferably 1.2 mm or larger and 1.4 mm or smaller.

11. The ignition method according to claim 2, wherein
the charge control and the discharge control are alternately repeated a plurality of times in the one cycle in the combustion chamber of the one cylinder, and
next charge control is performed before an end of discharge performed as the first discharge control in the spark plug in the one cycle.

12. The ignition method according to claim 1, wherein a mixing ratio of ammonia and hydrogen in the gaseous fuel supplied to the combustion chamber is adjusted on the basis of a result of detection of a pressure in the combustion chamber or a result of detection of an ion current flowing through a detection probe placed in the combustion chamber.

13. The ignition method according to claim 2, wherein
the gaseous fuel supplied to the combustion chamber of the one cylinder is ignited by discharge produced by respective spark plugs in a plurality of the ignition devices, and
discharge is caused to occur in the plurality of spark plugs in the combustion chamber of the one cylinder at the same timing in the one cycle, for the discharge control.

14. The ignition method according to claim 1, wherein a piston that reciprocates over a period of time from the compression stroke to the expansion stroke in the combustion chamber is controlled such that a position of a top dead center is variable, so that a compression ratio is increased as an engine load to the internal combustion engine decreases and the compression ratio is decreased as the engine load to the internal combustion chamber increases.

15. The ignition method according to claim 1, wherein a generated current of an alternator that generates power along with reciprocation of a piston that reciprocates over a period of time from the compression stroke to the expansion stroke in the combustion chamber is controlled, so that the generated current is increased as an engine load to the internal combustion engine decreases and the generated current is decreased as the engine load to the internal combustion engine increases.
